(19) United States
(12) Patent Application Publication
(10) Pub. No.: US 2015/0213199 A1
(43) Pub. Date: Jul. 30, 2015

(54) HEALTHCARE DATA MANAGEMENT SYSTEM

(71) Applicant: PreViser Corporation, Mt. Vernon, WA (US)

(72) Inventor: Carl Loeb, Mt. Vernon, WA (US)

(21) Appl. No.: 14/606,927

(22) Filed: Jan. 27, 2015

Related U.S. Application Data
(60) Provisional application No. 61/933,134, filed on Jan. 29, 2014.

(51) Int. Cl. G06F 19/00; G06F 21/62; H04L 29/06

(52) U.S. Cl. CPC G06F 19/322; G06F 19/3431; H04L 63/0428; G06F 21/6263

(57) ABSTRACT

A system including computing devices operated by a covered entity, patients, dentists, and a data processor. The data processor receives first and second de-identified data from the patients and dentists, respectively. The first and second de-identified data includes first and second identified data, respectively, encrypted using a public key associated with the covered entity. The first and second identified data includes first and second oral health risk scores, respectively, generated for the patients. The data processor lacks both authorization to access the first and second identified data and a private key required to decrypt the first and second de-identified data. The data processor transfers the first and second de-identified data to a computing device operated by the covered entity that is configured to decrypt the first and second de-identified data using the private key to obtain the first and second identified data for use locally by the computing device.

### CROSS REFERENCE TO RELATED APPLICATION(S)

This application claims the benefit of U.S. Provisional Application No. 61/933,134, filed on Jan. 29, 2014, which is incorporated herein by reference in its entirety.

### BACKGROUND OF THE INVENTION

1. Field of the Invention

The present invention is directed generally to healthcare data management systems used by covered entities under the Health Information Portability and Accountability Act (“HIPAA”), and particularly to systems used by insurance providers and/or dental service organizations.

2. Description of the Related Art

Managing healthcare costs and selecting appropriate insurance coverage are ongoing challenges. A need exists for systems configured to analyze healthcare needs of groups of patients to ensure they are receiving appropriate healthcare, have appropriate insurance coverage, and are receiving information necessary to help them address their healthcare needs. The present application provides these and other advantages as will be apparent from the following detailed description and accompanying figures.

### BRIEF DESCRIPTION OF THE SEVERAL VIEWS OF THE DRAWING(S)

FIG. 1 is a diagram of an exemplary system.

FIG. 2 is a diagram illustrating some software components and data stored by the computing devices of the system of FIG. 1.

FIG. 3A is a block diagram illustrating components of a self-assessment application.

FIG. 3B is a block diagram illustrating components of a clinical application.

FIG. 4 is a block diagram illustrating components of a management application.

FIG. 5A is a flow diagram of a method performed by the self-assessment application.

FIG. 5B is a flow diagram of a method performed by the clinical application.

FIG. 5C is a flow diagram of a method performed by the management application.

FIG. 6 depicts a first exemplary report generated by the self-assessment application and/or the clinical application.

FIG. 7 depicts a second exemplary report generated by the self-assessment application and/or the clinical application.

FIG. 8 depicts a third exemplary report generated by the self-assessment application and/or the clinical application.

FIG. 9 depicts a fourth exemplary report generated by the self-assessment application and/or the clinical application.

FIG. 10 depicts a fifth exemplary report generated by the self-assessment application and/or the clinical application.

FIG. 11 depicts a sixth exemplary report generated by the self-assessment application and/or the clinical application.

FIG. 12 depicts a seventh exemplary report generated by the self-assessment application and/or the clinical application.

FIG. 13 depicts a first exemplary report generated by the management application.

FIG. 14 depicts a second exemplary report generated by the management application.

FIG. 15 depicts a third exemplary report generated by the management application.

FIG. 16 depicts a fourth exemplary report generated by the management application.

FIG. 17 depicts a fifth exemplary report generated by the management application.

FIG. 18 depicts a sixth exemplary report generated by the management application.

FIG. 19 is a diagram of a hardware environment and an operating environment in which the computing devices of the system of FIG. 1 may be implemented.

### DETAILED DESCRIPTION OF THE INVENTION

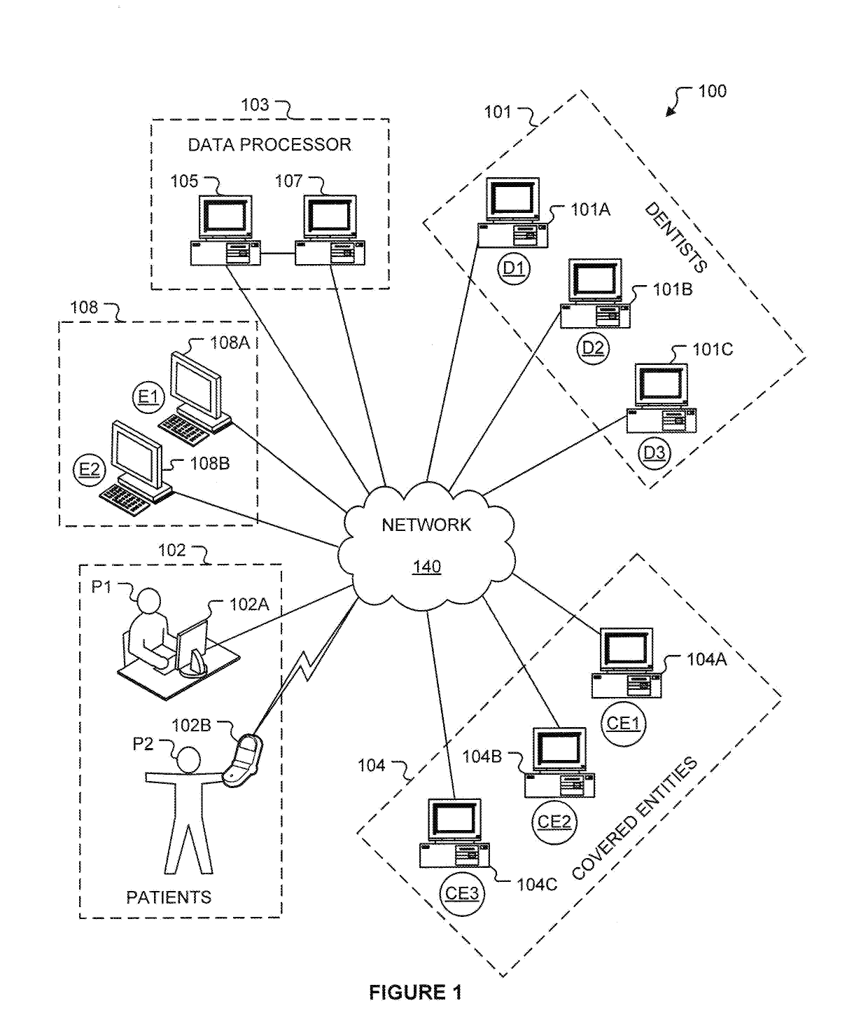

FIG. 1 depicts a system 100 used by five types of entities: (1) dentists 101; (2) patients 102; (3) a data processor 103; (4) covered entities 104; and (5) employers 108. The data processor 103 receives data from both the dentists 101 and the patients 102, and provides data to the covered entities 104. In the embodiment illustrated, the dentists 101 include three dentists D1-D3 operating computing devices 101A-101C, respectively. Further, in the embodiment illustrated, the patients 102 include two patients P1 and P2 operating computing devices 102A and 102B, respectively. In the embodiment illustrated, the covered entities 104 include three covered entities CE1-CE3 operating computing devices 104A-104C, respectively. Further, FIG. 1 illustrates two employers E1 and E2 operating computing devices 108A and 108B, respectively. However, the system 100 may include any number of dentists, patients, employers, and covered entities each operating any number of computing devices. The data processor 103 operates one or more computing devices. For ease of illustration, the data processor 103 is depicted in FIG. 1 as operating computing devices 105 and 107.

Each of the employers 108 may contract with one or more of the covered entities 104 with respect to the employer's employees (e.g., one or more of the patients 102). For example, the employers 108 may obtain insurance (e.g., dental insurance) from one or more of the covered entities 104 for the employer's employees (e.g., one or more of the patients 102). Further, the employers 108 may participate in wellness programs offered by those of the covered entities 104 with which the employers have contracted for insurance coverage.

As is appreciated by those of ordinary skill in the art, the patients 102 may contract individually with one or more of the covered entities 104 (e.g., to obtain dental coverage). Thus, each of the patients 102 may have a direct relationship with at least one of the covered entities 104 and/or a relationship via one of the employers 108. Alternatively, one or more of the patients 102 may not have a relationship with any of the covered entities 104.

The Health Insurance Portability and Accountability Act (“HIPAA”) restricts access to protected health information (“PHI”). The covered entities 104 are entities covered under HIPAA that are allowed to possess decrypted PHI with respect to at least some of the patients 102. Non-limiting examples of covered entities include insurance companies, dental service organizations, third party vendors working for companies managing wellness programs, government entities entitled under HIPAA to access PHI, and the like. Dental service organizations are corporate dental organizations that contract directly with an employer to provide dental care.

Data including PHI is referred to as “identified data.” Data that does not include PHI is referred to as “de-identified data.” Identified data can be converted to de-identified data by encrypting the identified data ensuring parties unable to decrypt the identified data cannot access the PHI. In the system 100, a particular patient, a dentist, and a covered entity may be authorized to access PHI with respect to a particular patient. For ease of illustration, the particular patient will be described as being the patient P1 with the dentist D2, and the covered entity CE3 both being authorized to access PHI with respect to the patient P1. Also for ease of illustration, the patient P1 will be described as being employed by the employer E1. The data processor 103 may avoid PHI entirely by storing and processing only de-identified data. This is accomplished using encryption.

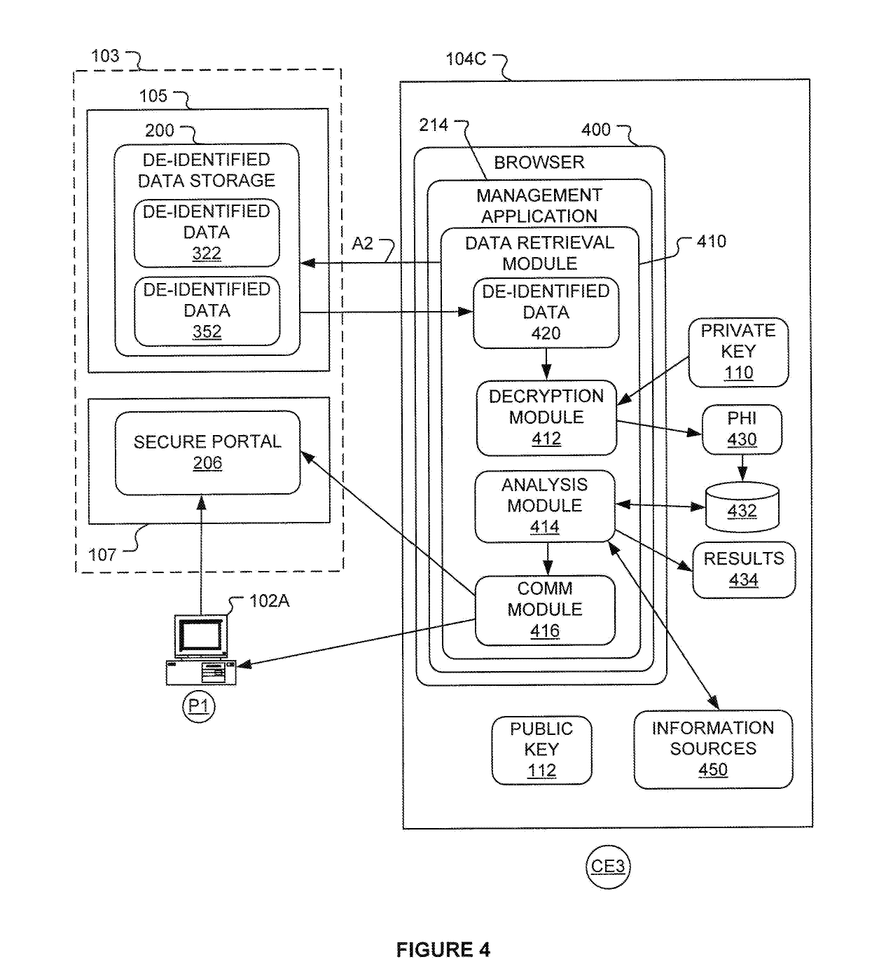

The system 100 may use asymmetrical encryption (e.g., RSA 128 asymmetrical encryption) between the patients 102 and the covered entities 104 (via the data processor 103). In such embodiments, each of the covered entities 104 may have a unique key pair that includes a private key, and a public key. For example, the covered entity CE3 has a private key 110 (see FIG. 4), and a public key 112 (see FIG. 4). Each of the covered entities 104 keeps its private key (e.g., the private key 110) secret. As will be described below, a copy of the public key (e.g., the public key 112) is provided to those of the patients 102 associated with the covered entity.

The system 100 may use either asymmetrical or symmetrical encryption between the dentists 101 and the covered entities 104. For data that is going to be used by (or shared with) one of the covered entities 104, the system 100 may use asymmetrical encryption (e.g., RSA 128 asymmetrical encryption) between the dentists 101 and the covered entities 104 (via the data processor 103). As will be explained below, a copy of the public key (e.g., the public key 112) associated with one of the covered entities 104 (e.g., the covered entity CE3) is provided to one of the dentists 101 (e.g., the dentist D2) when the dentist creates a patient record associated with one of the patients 102 (e.g., the patient P1) who is associated with the covered entity (e.g., the covered entity CE3).

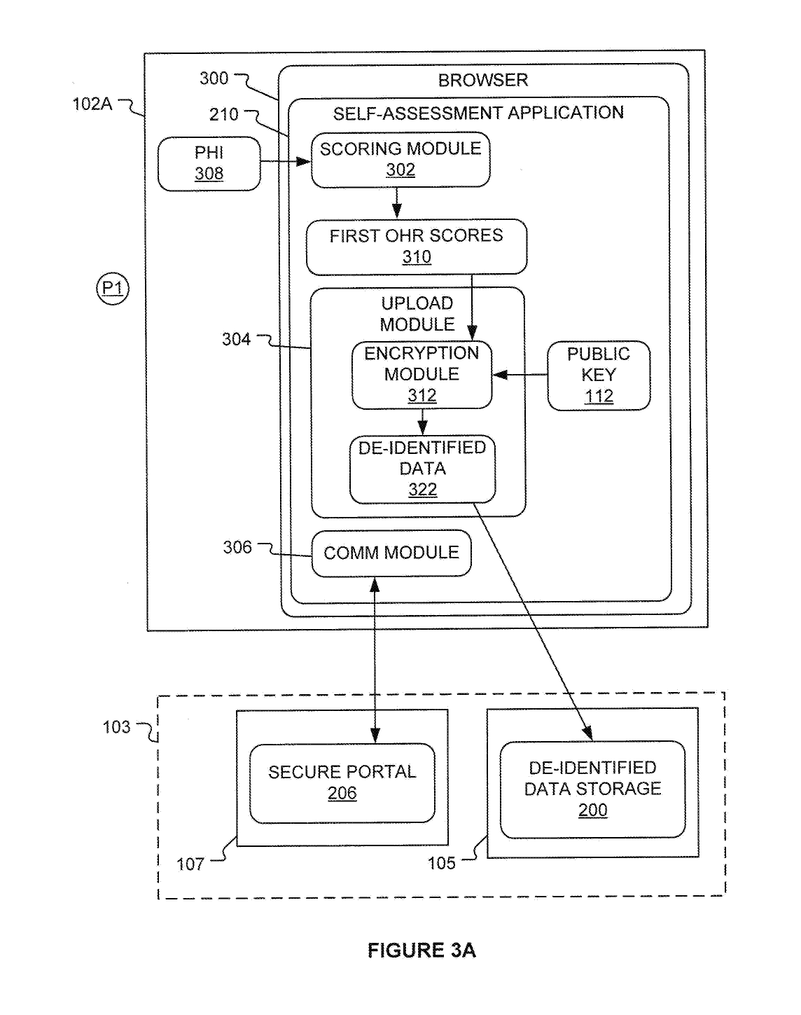

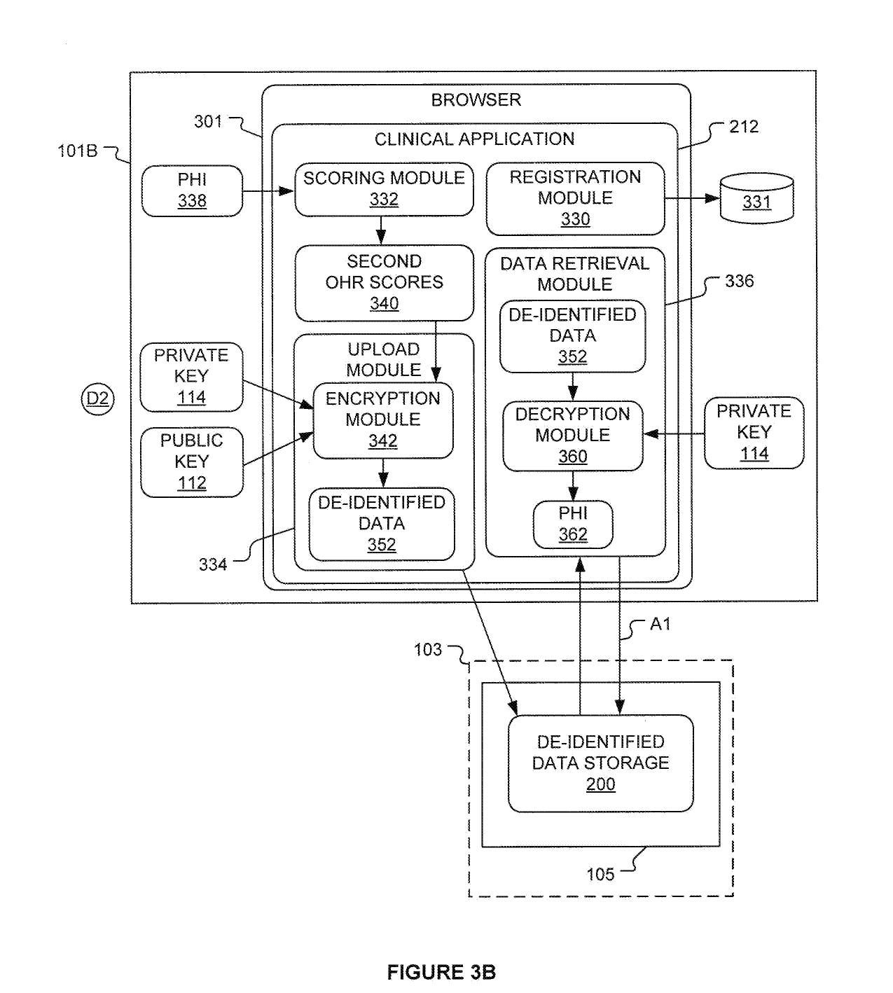

For data that is going to be used locally by the dentists 101 (and not used by (or shared with) one of the covered entities 104), the system 100 may use symmetrical encryption (e.g., symmetrical Advanced Encryption Standard (“AES”) 128 encryption) between the dentists 101 and the data processor 103. In such embodiments, each of the dentists 101 may have a unique private key (e.g., created by the dentist D2) that is not shared with the data processor 103. For example, the dentist D2 has a private key 114 (see FIG. 3B). For example, if a particular patient does not have a relationship with one of the covered entities 104, the system 100 may use symmetrical encryption between the dentist entering PHI related to the particular patient and the data processor 103. As will be explained below, the dentists 101 may upload de-identified PHI (encrypted using symmetrical encryption) to the data processor 103. The data processor 103 may store the de-identified PHI (encrypted using symmetrical encryption). The dentists 101 may subsequently download the de-identified PHI (encrypted using symmetrical encryption) and use it locally and/or use it to generate oral health risk (“OHR”) scores.

The data processor 103 does not have a copy of the private keys of either the dentists 101 or the covered entities 104. Therefore, the data processor 103 is unable to decrypt any data encrypted using the public keys of the covered entities 104 or the private keys of the dentists 101.

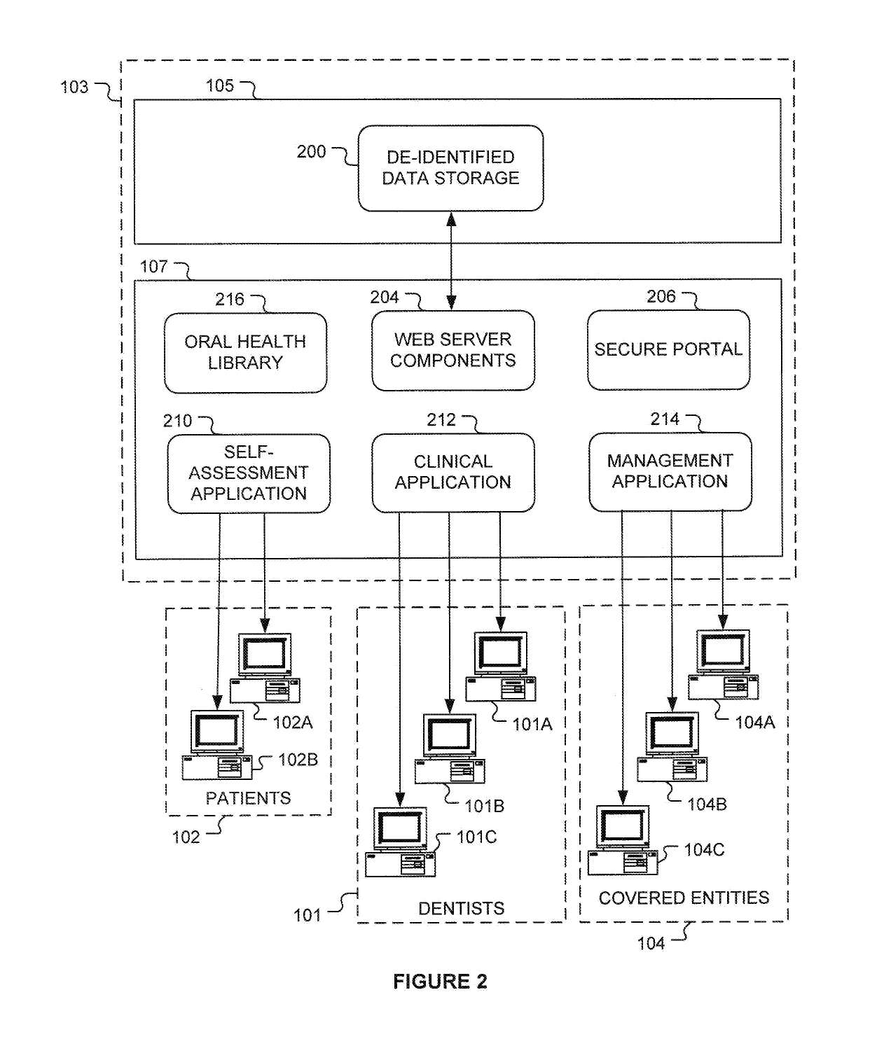

Referring to FIG. 2, the computing device 105 may include a de-identified data storage 200 (e.g., implemented as a database). The computing device 107 may be used to provide services (e.g., a web services) to the other computing devices in the system 100. For example, the computing device 107 may include conventional web server components 204 configured to generate a website configured to interact with one or more of applications 210, 212, and 214. Further, the computing device 107 may provide a secure portal 206 that may be accessed by the computing devices 102A and 102B operated by the patients 102 and/or the computing devices 104A-104C operated by the covered entities 104.

The data processor 103 may provide (e.g., via the computing device 107) copies of the self-assessment application 210 to the computing devices 102A and 102B operated by the patients 102. Alternatively, the data processor 103 may provide (e.g., via the computing device 107) copies of the self-assessment application 210 to the computing devices 108A and 108B (see FIG. 1) operated by the employers 108 (see FIG. 1). In such embodiments, the employers 108 may provide copies of the self-assessment application 210 to computing devices operated by their employees. For ease of illustration, the patients P1 and P2 will be described as both being employed by the employer E1. Thus, the employer E1 may provide copies of the self-assessment application 210 (via the computing device 108A) to the computing devices 102A and 102B operated by the patients P1 and P2, respectively. As mentioned above, for ease of illustration, the employer E1 has contracted with the covered entity CE3. Thus, the patients P1 and P2 are insured by the covered entity CE3. The public key 112 of the covered entity CE3 is included or programmed into the copy of self-assessment application 210 provided to the patients P1 and P2. Thus, a copy of the public key 112 may be provided to the computing devices 102A and 102B operated by the patients P1 and P2, respectively.

The self-assessment application 210 may be implemented as a web-based application configured to supply OHR scores to the patients 102 based on self-assessment information provided by the patients 102 to the self-assessment application 210.

The data processor 103 provides (e.g., via the computing device 107) copies of the clinical application 212 to the computing devices 101A-101C operated by the dentists 101. The clinical application 212 may be implemented as a web-based application configured to supply OHR scores to the dentists 101 based on clinical information provided by the dentists 101 to the clinical application 212.

The oral health self-assessment and clinical applications 210 and 212 may calculate values for the same OHR scores. For example, the OHR scores (calculated by the oral health self-assessment and clinical applications 210 and 212) may include (1) health risk scores for periodontal disease, caries, and oral cancer, (2) severity scores for periodontal disease, and (3) restorative need scores. Table A (below) provides examples of six OHR scores (namely, caries risk, restorative needs, periodontal disease risk, periodontal disease severity, periodontal health stability, and oral cancer risk) in the leftmost column, scales (middle column) that may be used to assign values to each score, and a description of what the values in each scale indicates in the rightmost column.

TABLE A

| OHR Score | Scale | Description of what value assigned to score indicates |
|---|---|---|
| Caries Risk | 1-5 | likelihood that new carious lesions will develop, or existing |
| | | restorations will fail. A score of 1 indicates very low risk, while a score |
| | | of 5 very high risk. |
| Restorative | 1-100 | overall health of the visible teeth. A score of 1 means no |
| Needs | | visible natural teeth have decay or a restoration. Scores |
| | | from 2-9 reflect the percentage of visible natural teeth that |
| | | have a restoration and that all restorations are sound. A |
| | | score of 2 indicates less than 14% of the visible teeth |
| | | (e.g., 3 or less teeth of a 28-tooth dentition, 2 or less teeth |
| | | of a 20-tooth dentition) have been restored and all |
| | | restorations are sound. A score of 9 indicates that at least |
| | | 89% of the visible teeth (e.g., 25 or more teeth of a 28- |
| | | tooth dentition, 18 or more teeth of a 20-tooth dentition) |
| | | are restored and all restorations are sound. Scores from |
| | | 10-100 indicate increasing numbers of active lesions or |
| | | defective restorations. A score of 10 indicates that |
| | | approximately 10% of the dentition is affected, while a |
| | | score of 100 indicates that 100% of the dentition has |
| | | active lesions or defective restorations. |
| Periodontal | 1-5 | likelihood that the current periodontal status will |
| disease risk | | deteriorate without appropriate home and professional |
| | | care. A score of 1 indicates very low risk, while a score of |
| | | 5 indicates very high risk. |
| Periodontal | 1-100 | summarizes severity of a patient's overall periodontal |
| disease | | status. A score of 1 indicates a healthy condition defined |
| severity | | as no bleeding sites, no pockets, and no bone loss. |
| | | Scores of 2-3 indicate gingivitis (defined as some sites |
| | | bleeding, but no deep pockets or bone loss), 4-10 mild |
| | | periodontitis, 11-36 moderate periodontitis, and 37-100 |
| | | severe periodontitis. Periodontitis severity is defined by |
| | | the depth of the pockets and magnitude of bone loss. |
| | | Small changes in periodontal disease status will be |
| | | reflected in changes in this score. |
| Periodontal | 0-100 | duration during which gum disease risk and severity |
| health | | scores have remained unchanged within set parameters. |
| stability | | A score of 0 indicates a patient's first-ever assessment, or |
| | | that a patient's risk or severity scores have changed |
| | | beyond set parameters. As the duration of stability |
| | | increases, this score increases. The maximum score |
| | | increment for one year is 10. |
| Oral cancer | 1-5 | exposure to risk factors implicated in oral cancer. A score |
| risk | | of 1 indicates very low exposure to risk factors, while a |
| | | score of 5 signifies very high exposure. |

Exemplary methods of calculating OHR scores are described in U.S. Pat. Nos. 6,484,144, 8,206,154, and 8,267,689, which are incorporated herein by reference in their entireties. The self-assessment application 210 and/or the clinical application 212 may use information stored in an oral health library 216 when determining the OHR scores. The oral health library 216 may include articles on oral health topics (e.g., including illustrations and photographs).

Optionally, the data processor 103 may provide (e.g., via the computing device 107) copies of the management application 214 to the computing devices 104A-104C operated by the covered entities 104. The management application 214 may be implemented as a web-based application configured to download de-identified data from the de-identified data storage 200, decrypt the downloaded data, and analyze the decrypted data.

### Self-Assessment Application

Referring to FIG. 3A, the self-assessment application 210 may be characterized as including a scoring module 302, an upload module 304, a communication module 306, and, optionally, a copy of a public key (e.g., the public key 112) associated with one of the covered entities 104. The scoring module 302 is configured to calculate OHR scores based at least in part on PHI (e.g., answers to questions) provided by the patients 102. The upload module 304 is configured to encrypt data and upload the encrypted data to the de-identified data storage 200. The communication module 306 is configured to access the secure portal 206.

As mentioned above, when the self-assessment application 210 is obtained from one of the employers 108 (see FIG. 1), the self-assessment application 210 may include the public key associated with one of the covered entities 104 (e.g., the public key 112 associated with the covered entity CE3). Alternatively, the copy of the public key may be obtained directly from one of the covered entities 104 (e.g., if the self-assessment application 210 is being executed by a kiosk operated by one of the covered entities 104).

If the self-assessment application 210 does not include a copy of a public key associated with one of the covered entities 104, the self-assessment application 210 may be used to generate OHR score values but does not store them (or other PHI) with the data processor 103. Thus, optionally, the self-assessment application 210 may ask the patient for information identifying one of the covered entities 104 as the patient's insurer.

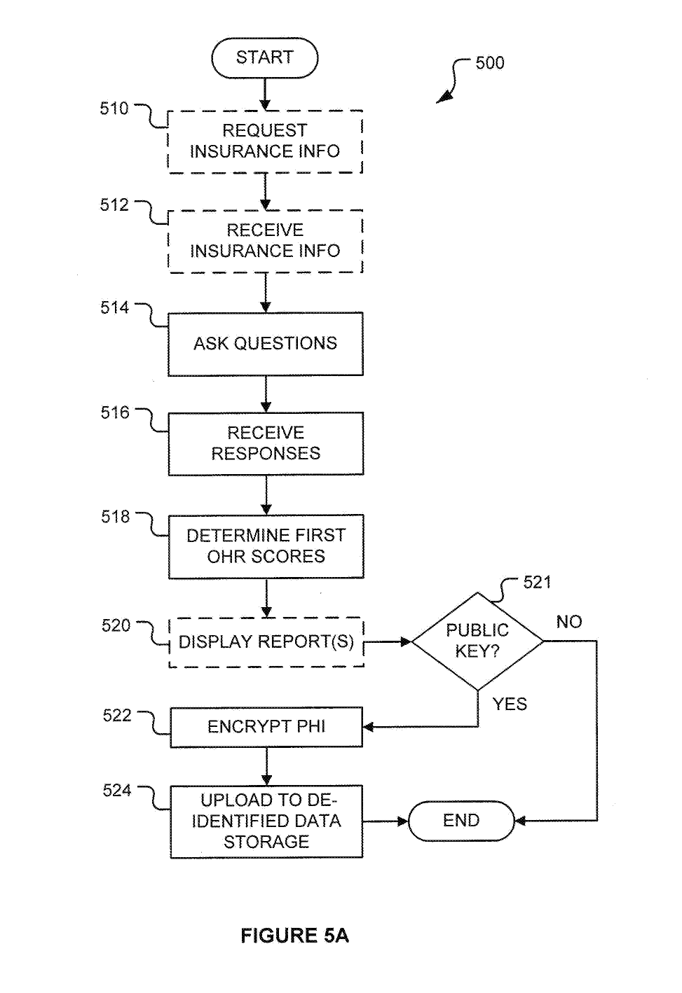

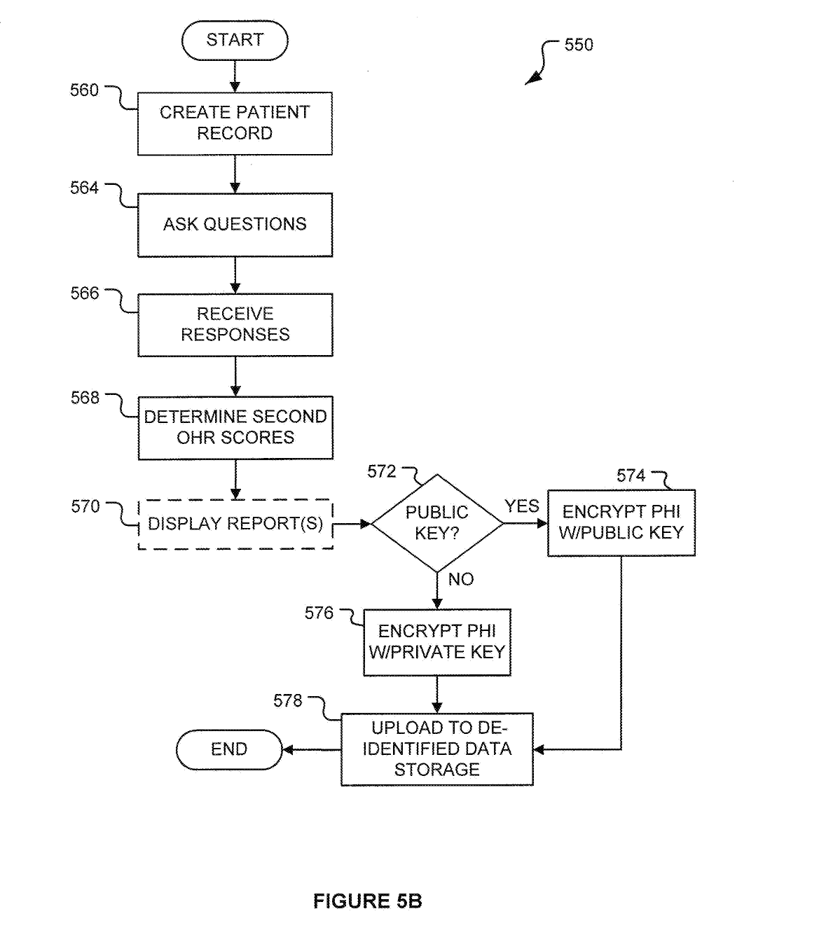

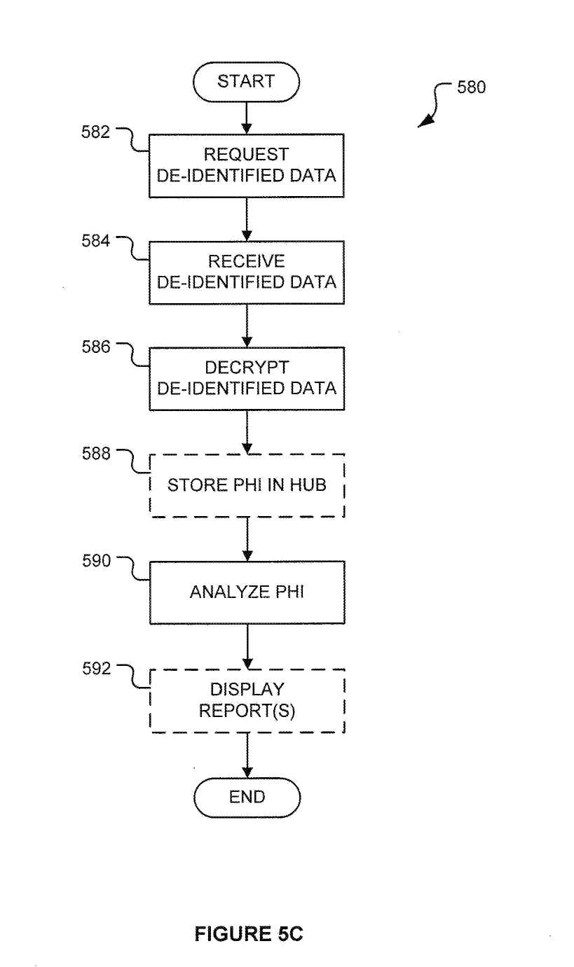

FIG. 5A is a flow diagram of a method 500 that may be performed by the self-assessment application 210. For ease of illustration, the method 500 will be described as being performed with respect to the patient P1. The following description of the method 500 illustrated in FIG. 5A refers to components illustrated in FIG. 3A. In optional first block 510, the self-assessment application 210 may request insurance information via a user interface (not shown), such as a webpage. The insurance information requested identifies one of the covered entities 104 as insuring the patient P1. The patient P1 may optionally provide the information requested or may decline to do so. If the patient P1 provides the insurance information, in optional block 512, the self-assessment application 210 receives the insurance information from the patient P1. Optionally, the self-assessment application 210 may use the information provided in block 512 to identify a public key associated with the covered entity and/or obtain a copy of the public key (e.g., from the covered entity). By way of a non-limiting example, blocks 510 and 512 may be performed when the self-assessment application 210 does not include a copy of a public key associated with one of the covered entities 104.

In block 514, the self-assessment application 210 asks the patient P1 a series of questions via a user interface (not shown), such as a webpage. For example, the questions may relate to the health of the patient's teeth, gums, and soft tissues. The questions may also request patient information, such as name, address, etc. The patient P1 uses the computing device 102A to supply responses (illustrated as PHI 308 in FIG. 3A) to the questions, which are received by the self-assessment application 210 in block 516. These responses are provided to the scoring module 302 of the self-assessment application 210. In block 518, the scoring module 302 calculates first OHR scores 310 based at least in part on the PHI 308. The first OHR scores 310 may be characterized as being estimated OHR scores because they are based on patient provided non-clinical information. The first OHR scores 310 themselves are also considered to be PHI. The self-assessment application 210 may execute inside a browser application 300 executing on the computing device 102A, and may communicate with the web server components 204 (see FIG. 2) executing on the computing device 107. However, the self-assessment application 210 does not communicate either the PHI 308 or unencrypted copies of the first OHR scores 310 to either the computing device 107 or the data processor 103.

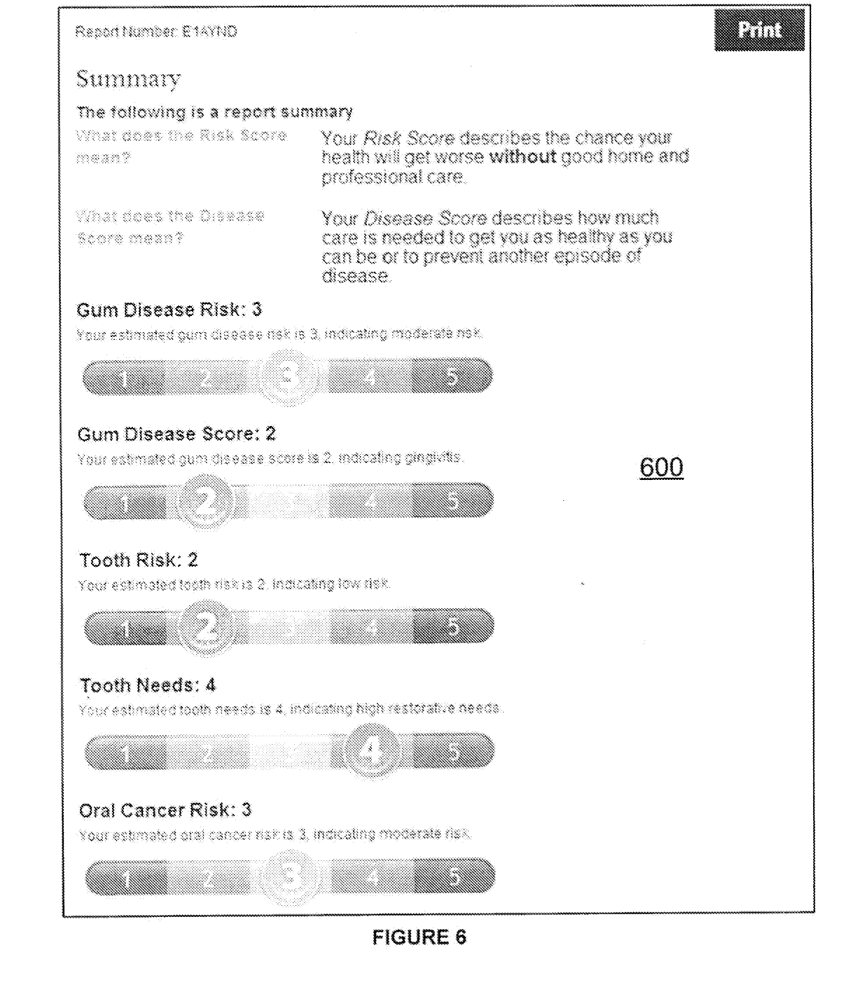

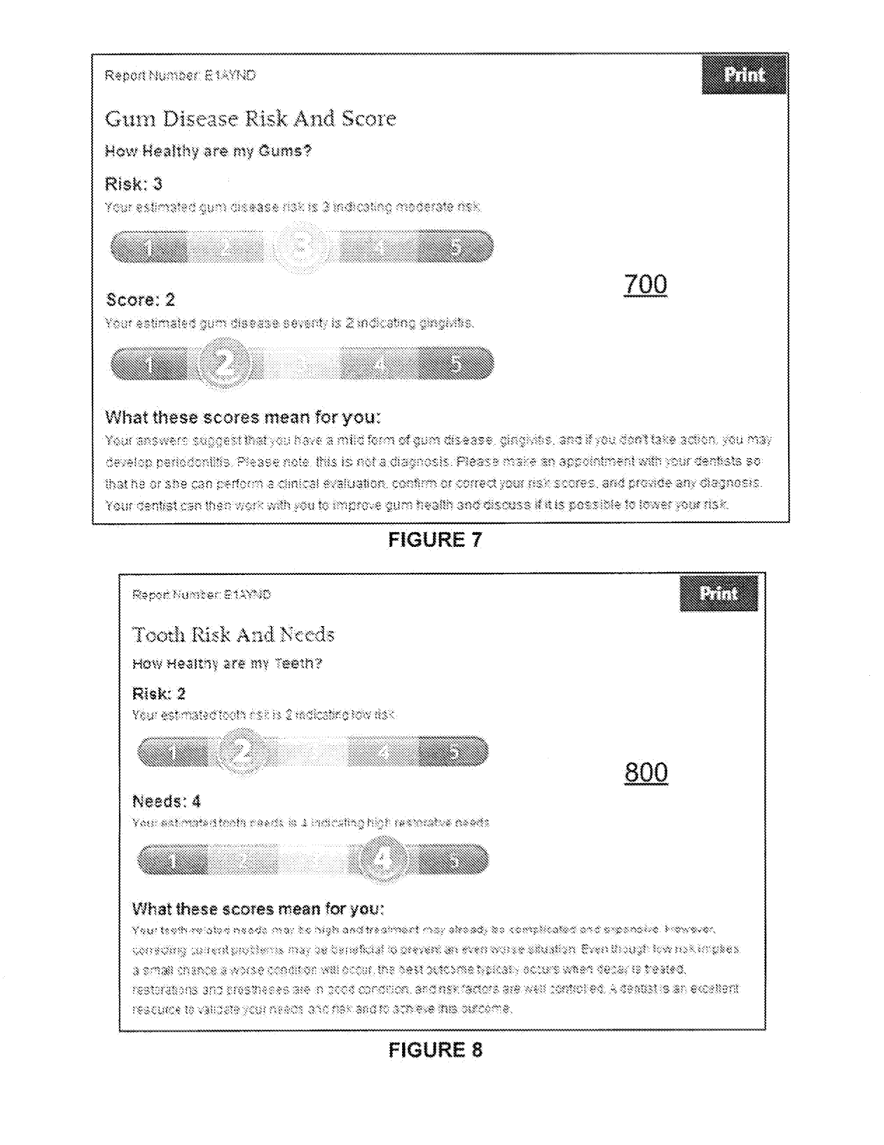

The self-assessment application 210 may be configured to generate reports, and display them to the patients 102. For example, in optional block 520, the self-assessment application 210 may generate a report displaying the first OHR scores 310 to the patient P1. FIGS. 6-8 depict example reports 600-800, respectively, that may be displayed in block 520. In the reports 600-800, the OHR score values are provided on scale (e.g., from one to five), indicating risk (from very low to very high) and current treatment needs (from very little to significant needs). For example, the report 600 indicates the patient P1 has a level three risk of gum disease. Further, the reports 600-800 may include explanations of the OHR scores.

The self-assessment application 210 may be used to access oral health information stored in the oral health library 216, and display such information to the patients 102. For example, the report(s) displayed in block 520 may include one or more links to information stored in the oral health library 216. For example, links may be provided to topics in the oral health library 216 that relate to the first OHR scores 310 of the patient P1.

Optionally, the self-assessment application 210 may ask the patient P1 to provide an email address to which a copy of the report(s) may be delivered. Optionally, the email may include a recommendation for an insurance policy that fits the first OHR scores 310 of the patient P1.

In decision block 521, the self-assessment application 210 determines whether it has a local copy of a public key that may be used to encrypt the first OHR scores 310 of the patient P1. The decision in decision block 521 is “YES” when the self-assessment application 210 has a local copy of a public key that may be used to encrypt the first OHR scores 310 of the patient P1. On the other hand, the decision in decision block 521 is “NO” when the self-assessment application 210 does not have a local copy of a public key that may be used to encrypt the first OHR scores 310 of the patient P1. When the decision in decision block 521 is “NO,” the method 500 terminates.

Optionally, when the decision in decision block 521 is “NO,” the self-assessment application 210 may display an option (or link) to visit a website operated by one of the covered entities 104 whereat the patient P1 may receive information on insurance policies that may be appropriate for the patient P1 (e.g., based on the estimated OHR scores).

When the decision in decision block 521 is “YES,” the self-assessment application 210 advances to block 522. The upload module 304 includes an encryption module 312 that in block 522, encrypts data (e.g., the first OHR scores 310, at least a portion of the PHI 308, and the like) using a local copy of a public key (e.g., the public key 112) to create de-identified data 322. Information identifying the covered entity (e.g., the covered entity CE3) associated with the public key (e.g., the public key 112) is included with the de-identified data 322 but is not encrypted.

In block 524, the upload module 304 transmits the de-identified data 322 and the information identifying the covered entity (e.g., the covered entity CE3) to the de-identified data storage 200 operated by the data processor 103. Then, the method 500 terminates.

In the method 500, the de-identified data created by the self-assessment application 210 and stored in the de-identified data storage 200 may have been encrypted at the browser level.

By way of non-limiting examples, the self-assessment application 210 may be implemented at an enterprise level for one or more of the covered entities 104. In such embodiments, the self-assessment application 210 is made available to all patients who are insured by the one or more participating covered entities (e.g., insurance companies). The self-assessment application 210 can be implemented on mobile kiosks and/or deployed on touch screen computers. The kiosks can be deployed and used at health fairs, wellness events at employer facilities, other public places, and the like. The self-assessment application 210 can be implemented for the participating dentists 101 (see FIG. 1). In such embodiments, the self-assessment application 210 may be offered by the participating dentists to their patients, and hosted on practice websites.

The patients 102 may verify OHR scores obtained from the self-assessment application 210 with one of the dentists 101. For example, the patient P1 may verify the first OHR scores 310 with the dentist D2. The self-assessment application 210 may encourage the patients 102 (e.g., the patient P1) to print and take a copy of one or more of the reports 600-800 (see FIGS. 6-8, respectively) including their OHR scores (e.g., the first OHR scores 310) to one of the dentists 101 (e.g., the dentist D2), emphasizing the importance of verifying report results with clinical measurements only a dentist can provide.

### Clinical Application

Referring to FIG. 3B, the clinical application 212 may be characterized as including a registration module 330, a scoring module 332, an upload module 334, and a data retrieval module 336. The clinical application 212 may include or communicate with a patient record storage 331. The dentists 101 use the registration module 330 to create and store patient records in the patient record storage 331. When the dentist D2 creates a patient record (e.g., for the patient P1) using the clinical application 212, the dentist associates the patient with one of the covered entities 104 (e.g., a particular insurer). The registration module 330 associates the patient with the public key (e.g., the public key 112) of the covered entity associated with the patient. For example, the public key 112 may be associated with the patient P1 in the patient record storage 331 operated by the dentist D2.

The scoring module 332 functions substantially identically to the scoring module 302 of the self-assessment application 210, except the scoring module 332 is configured to calculate OHR scores based at least in part on PHI (e.g., clinical information) provided by the dentists 101. The upload module 334 is configured to encrypt data and upload the encrypted data to the de-identified data storage 200. The data retrieval module 336 is configured to retrieve encrypted data from the de-identified data storage 200, and decrypt the encrypted data.

FIG. 5B is a flow diagram of a method 550 that may be performed by the clinical application 212. For ease of illustration, the method 550 will be described as being performed with respect to the dentist D2 providing information related to the patient P1. The following description of the method 550 illustrated in FIG. 5B refers to components illustrated in FIG. 3B. In first block 560, the dentist D2 101 uses the registration module 330 to create and store a patient record for the patient P1 in the patient record storage 331. The dentist D2 may enter patient information (such as name, address, etc.) into the patient record. When the dentist D2 creates the patient record, the dentist may associate the patient with one of the covered entities 104 (e.g., a particular insurer). The registration module 330 associates the patient with the public key (e.g., the public key 112) of the covered entity associated with the patient. For example, the public key 112 may be associated with the patient P1 in the patient record storage 331 operated by the dentist D2.

In block 564, the clinical application 212 asks the dentist D2 a series of questions via a user interface (not shown), such as a webpage. For example, the questions may relate to the health of the patient's teeth, gums, and soft tissues. The dentist D2 uses the computing device 101B to supply responses (illustrated as PHI 338 in FIG. 3B) to the questions, which are received by the clinical application 212 in block 566. These responses are provided to the scoring module 332 of the clinical application 212.

In block 568, the scoring module 332 calculates second OHR scores 340 that have values corresponding to the first OHR scores 310 calculated by the self-assessment application 210, but with greater clinical precision. The scoring module 302 calculates the second OHR scores 340 based at least in part on the PHI 338. As mentioned above, the first OHR scores 310 may be considered to be estimated OHR scores. The second OHR scores 340 may be considered to be verified (by a dentist) OHR scores. The second OHR scores 340 themselves are also considered to be PHI. The clinical application 212 may execute inside a browser application 301 executing on the computing device 101B, and may communicate with the web server components 204 (see FIG. 2) executing on the computing device 107. However, the clinical application 212 does not communicate either the PHI 338 or unencrypted copies of the second OHR scores 340 to either the computing device 107 or the data processor 103.

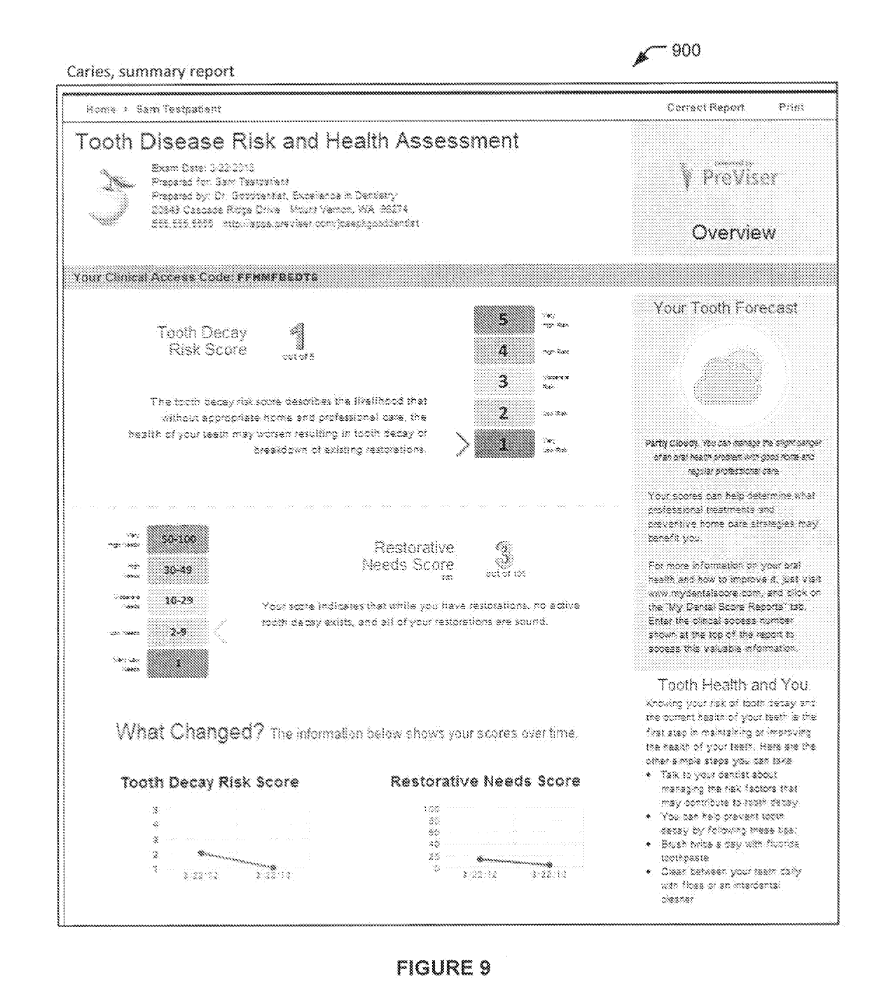

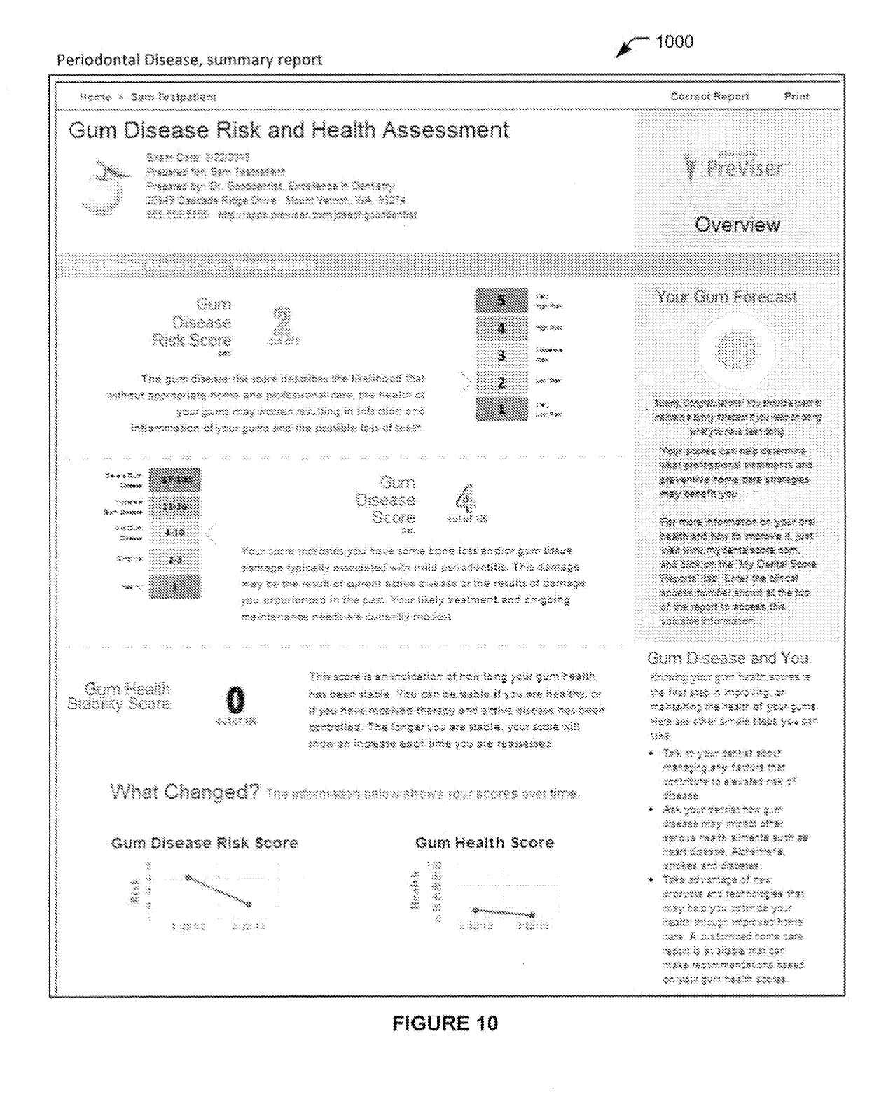

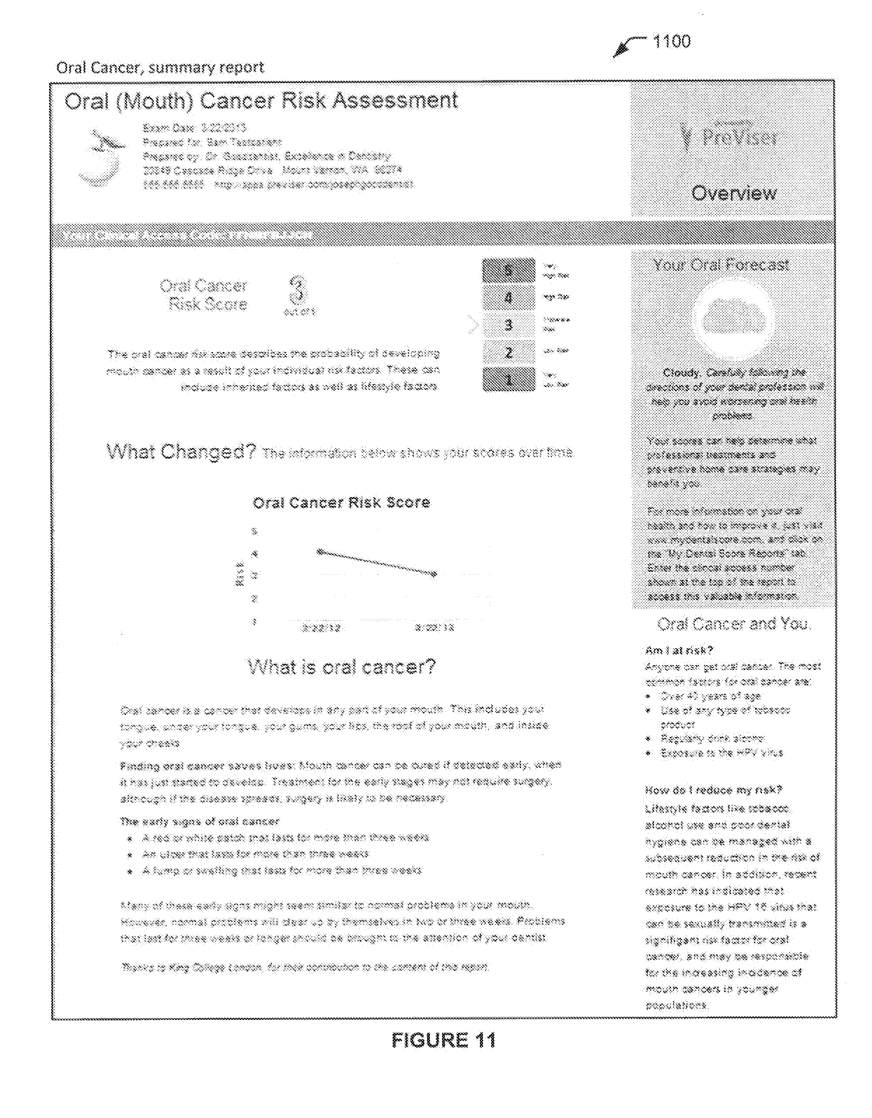

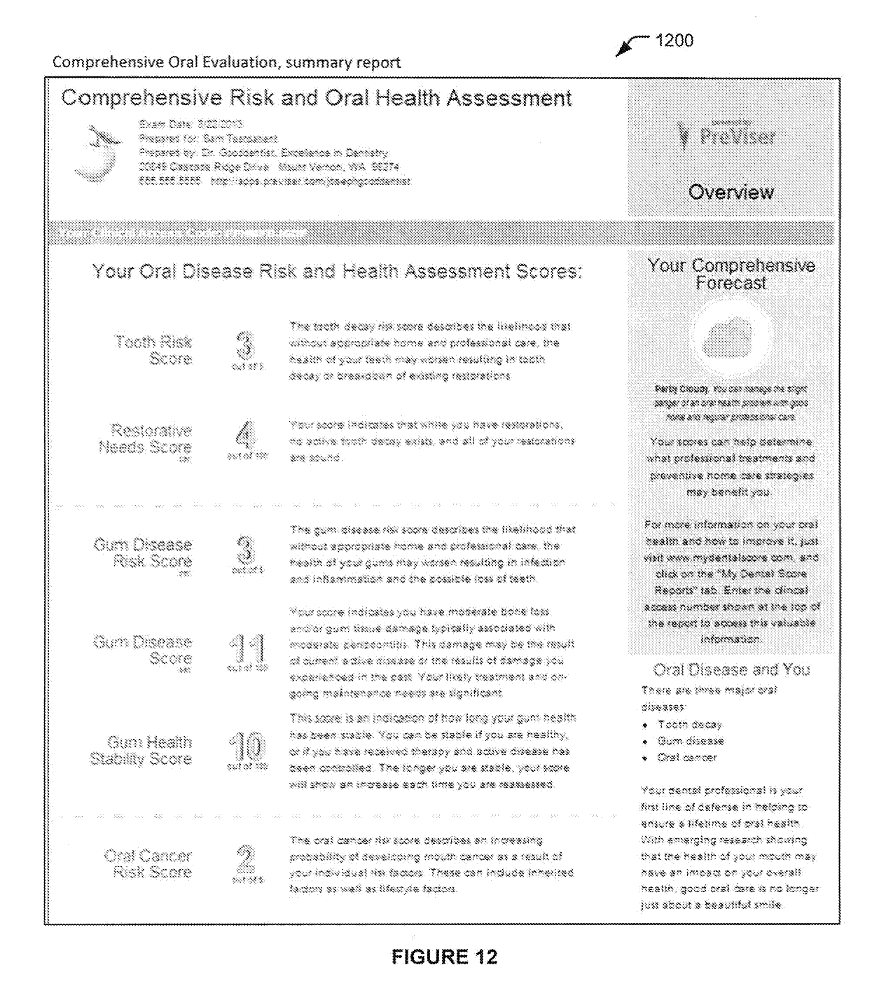

The clinical application 212 may be configured to generate reports, and display them to the dentists 101 and/or the patients 102. For example, in optional block 570, the clinical application 212 may generate a report displaying the second OHR scores 340 to the dentist D2 and/or the patient P1. FIGS. 9-12 depict example reports 900-1200, respectively, that may be displayed in block 570. In the reports 900-1200, the OHR scores are provided on scale (e.g., from one to five), indicating risk (from very low to very high) and current treatment needs (from very little to significant needs, for example, on a scale of one to one hundred). Further, the reports 900-1200 may include explanations of the OHR scores. Optionally, the report(s) may be printed and a copy provided to the patient P1.

The clinical application 212 may be used to access oral health information stored in the oral health library 216, and display such information to the dentists 101 and/or the patients 102. For example, the report(s) displayed in block 570 may include one or more links to information stored in the oral health library 216. Such links may include links to topics in the oral health library 216 that relate to the second OHR scores 340 of the patient P1.

The upload module 334 includes an encryption module 342 that may encrypt data (e.g., the second OHR scores 340, at least a portion of the PHI 338, and the like) using either a local copy of the public key 112 or a local copy of the private key 114. Referring to FIG. 5B, in decision block 572, the clinical application 212 determines whether to encrypt the data (e.g., the second OHR scores 340, at least a portion of the PHI 338, and the like) using a local copy of a public key (e.g., the public key 112) or a local copy of a private key (e.g., the private key 114). By way of a non-limiting example, the decision in decision block 572 may be “YES” when the patient record is associated with one of the covered entities 104 and a public key associated with that covered entity. On the other hand, the decision in decision block 572 may be “NO” when the patient record is not associated with one of the covered entities 104 or a public key.

The decision in decision block 572 is “YES” when the data is to be encrypted using a local copy of a public key (e.g., the public key 112). When the decision in decision block 572 is “YES,” in block 574, the encryption module 342 encrypts the data (e.g., the second OHR scores 340, at least a portion of the PHI 338, and the like) using the local copy of a public key (e.g., the public key 112) to create de-identified data 352. If the patient record includes information identifying the covered entity CE3, such information is included with the de-identified data 352 but is not encrypted.

The decision in decision block 572 is “NO” when the data is to be encrypted using a local copy of a private key (e.g., the private key 114). When the decision in decision block 572 is “NO,” in block 576, the encryption module 342 creates the de-identified data 352 by encrypting the data (e.g., the second OHR scores 340, at least a portion of the PHI 338, and the like) using the local copy of a private key (e.g., the private key 114). Information identifying the dentist D2 (e.g., a dentist identifier) may be included with the de-identified data 352 but is not encrypted.

In block 578, the upload module 334 transmits the de-identified data 352 and the information identifying the covered entity CE3 and/or the dentist D2, if present, to the de-identified data storage 200 operated by the data processor 103. Then, the method 550 terminates.

In the method 550, the de-identified data 352 created by the clinical application 212 and stored in the de-identified data storage 200 may have been encrypted at the browser level.

The data retrieval module 336 may be used to retrieve the de-identified data 352 from the data processor 103. The data retrieval module 336 sends a request (represented by arrow A1) for the de-identified data 352 to the data processor 103. Because the dentist D2 uploaded the de-identified data 352, in the de-identified data storage 200, the de-identified data 352 is associated with the dentist D2 (e.g. via the dentist identifier uploaded and/or associated with the de-identified data 352). If the dentist D2 successfully completed an authentication process (e.g., a login procedure), the data retrieval module 336 downloads the de-identified data 352.

The data retrieval module 336 includes a decryption module 360 configured to use the local copy of the private key 114 to decrypt the de-identified data 352 to obtain PHI 362 (which may include, for example, the second OHR scores 340, at least a portion of the PHI 338, and the like). The clinical application 212 may generate reports (e.g., one or more of the reports 900-1200 depicted in FIGS. 9-12, respectively) based at least in part on the retrieved data, and display the reports to the dentists 101 and/or the patients 102. For example, the clinical application 212 may generate a report during a dentist visit, and display the report to the patient P1. Optionally, the report(s) may be printed and a copy provided to the patient P1.

### Verification by Patient

Optionally, the self-assessment application 210 may allow the patient P1 generate the second OHR scores 340. For example, the self-assessment application 210 may include a “Dentist Form” and an option to “Enter Dentist Provided Data.” The “Dentist Form” may list clinical questions (e.g., at least a portion of the questions presented in block 564 of the method 550 depicted in FIG. 5B) that the dentist D2 can answer and that are needed to complete a clinical assessment. The patient P1 may print the form and ask the dentist D2 the questions on the form. After answers to the questions have been collected by the patient P1, the patient P1 can select the option to “Enter Dentist Provided Data,” and enter the answers.

After the answers have been entered by the patient P1, the scoring module 302 generates the second OHR scores 340. Optionally, the report(s) described with respect to block 520 of the method 500 and/or block 570 of the method 550 may be displayed to the patient P1. Further, the upload module 304 may encrypt and upload the second OHR scores 340 to the de-identified data storage 200. If the patient P1 provided insurance information identifying one of the covered entities 104 that information is included with the upload but is not encrypted.

### Management Application

Referring to FIG. 4, the management application 214 may be characterized as including a data retrieval module 410 that includes a decryption module 412, an analysis module 414, and a communication module 416. The covered entity CE3 uses the data retrieval module 410 of the management application 214 executing on the computing device 104C to download de-identified data 420 associated with the covered entity CE3.

The data processor 103 associates the de-identified data 322 and the de-identified data 352 (which include the encrypted first and second OHR scores 220 and 222, respectively) stored in the de-identified data storage 200 with the covered entity CE3 using the information identifying the covered entity CE3 uploaded with the de-identified data 322 and the de-identified data 352.

FIG. 5C is a flow diagram of a method 580 that may be performed by the management application 214. For ease of illustration, the method 580 will be described as being performed with respect to the covered entity CE3. The following description of the method 580 illustrated in FIG. 5C refers to components illustrated in FIG. 4.

In first block 582, the data retrieval module 410 sends a request (represented by an arrow A2) to the de-identified data storage 200 for de-identified data (illustrated in FIG. 4 as de-identified data 420) associated with the covered entity CE3. The management application 214 may automatically (e.g., periodically) send the request (represented by the arrow A2) for data from the de-identified data storage 200. For example, the management application 214 may send a request about every two minutes.

In block 584, the data retrieval module 410 receives the de-identified data 420. Only that data belonging to the covered entity CE3 is transmitted (as the de-identified data 420) by the data processor 103 in response to the request. Continuing the example from above, the de-identified data 420 includes the encrypted first and second OHR scores 220 and 222. Optionally, the de-identified data 420 may include at least a portion of the PHI 308 (see FIG. 3A) and/or at least a portion of the PHI 338 (see FIG. 3B). Further, the de-identified data 420 may include OHR scores for other patients.

In block 586, the decryption module 412 decrypts the de-identified data 420 locally as PHI 430. In optional block 588, the data retrieval module 410 may store the PHI 430 in a data integration hub 432, which may be implemented using a relational database (e.g., a Microsoft SQL database).

All or portions of the management application 214 may execute inside a browser application 400 executing on the computing device 104C, and may communicate with the web server components 204 (see FIG. 2) executing on the computing device 107. However, the management application 214 does not communicate the PHI 430 to either the computing device 107 or the data processor 103.

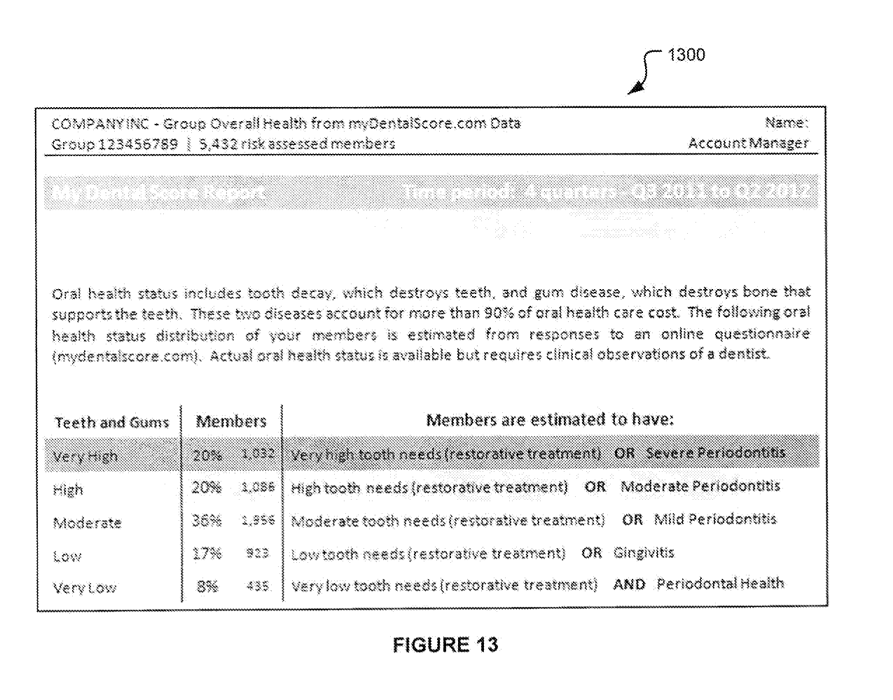

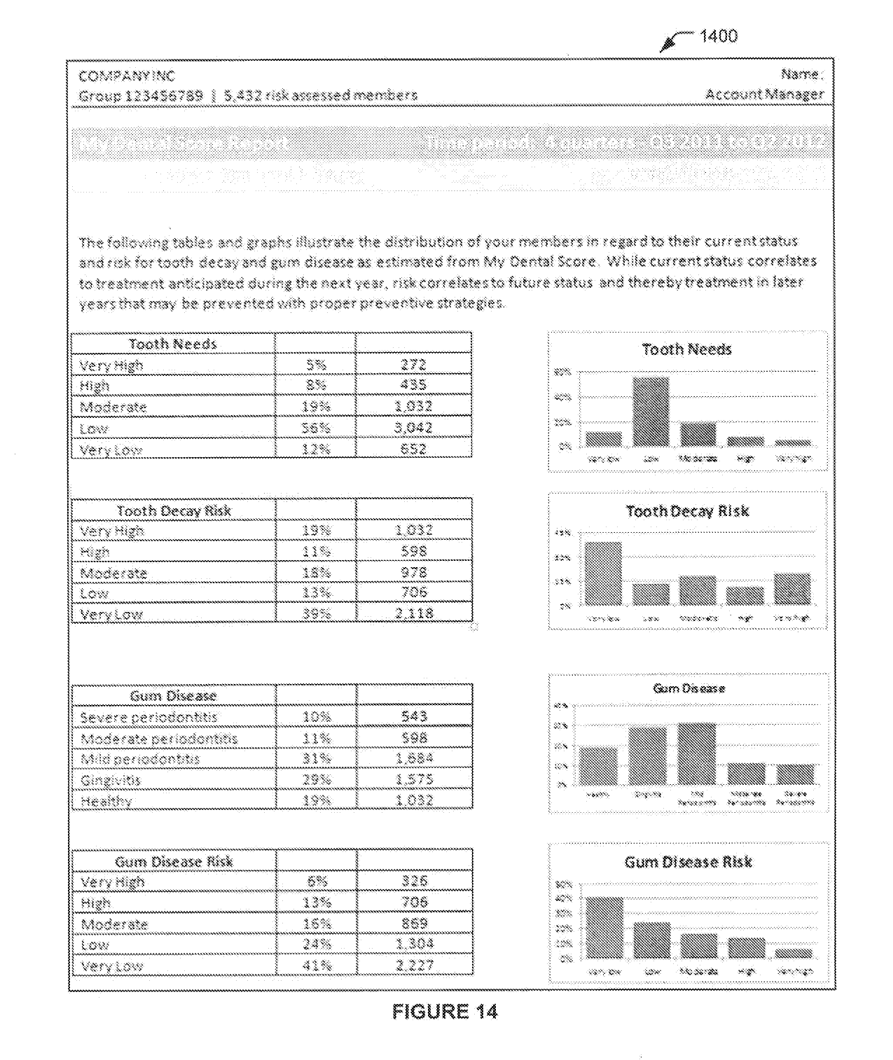

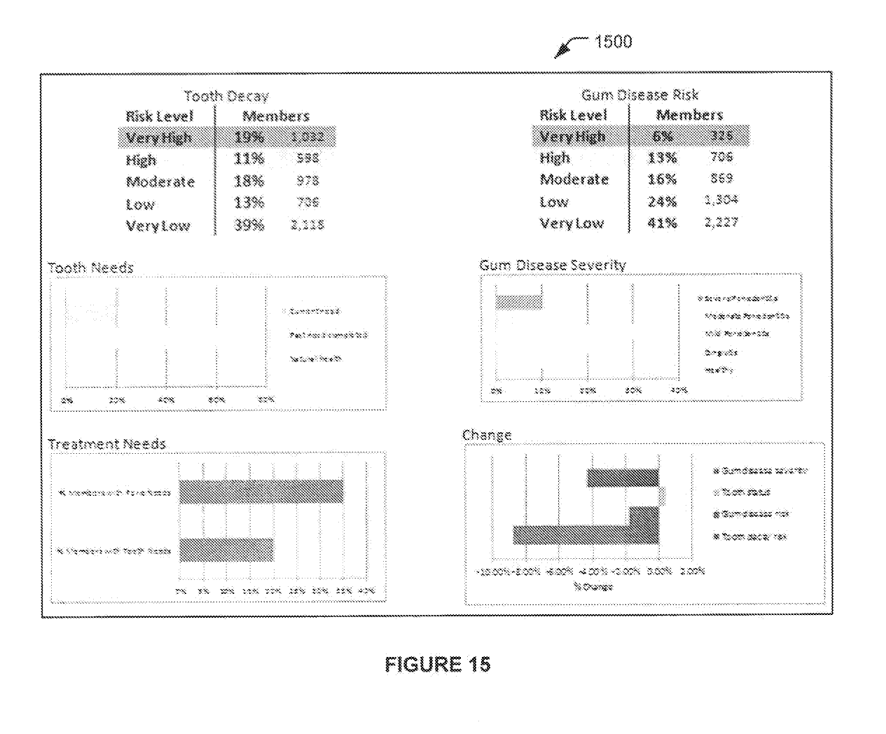

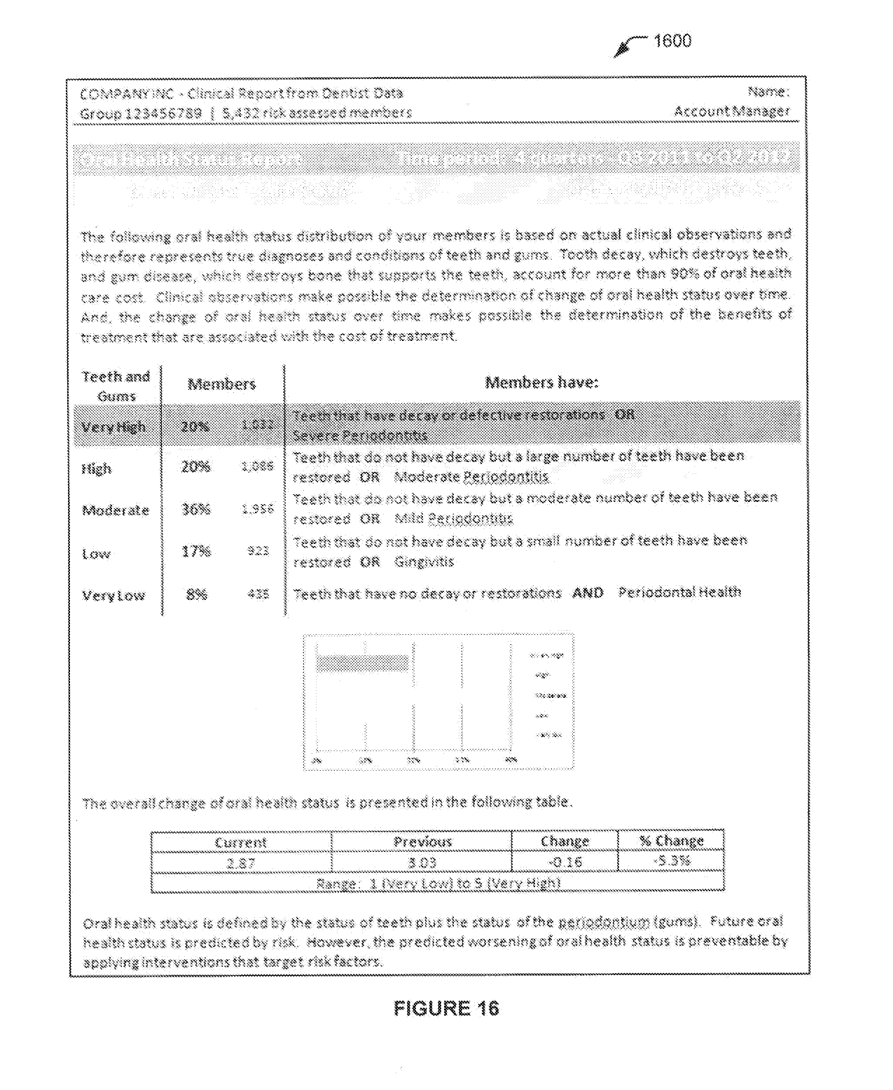

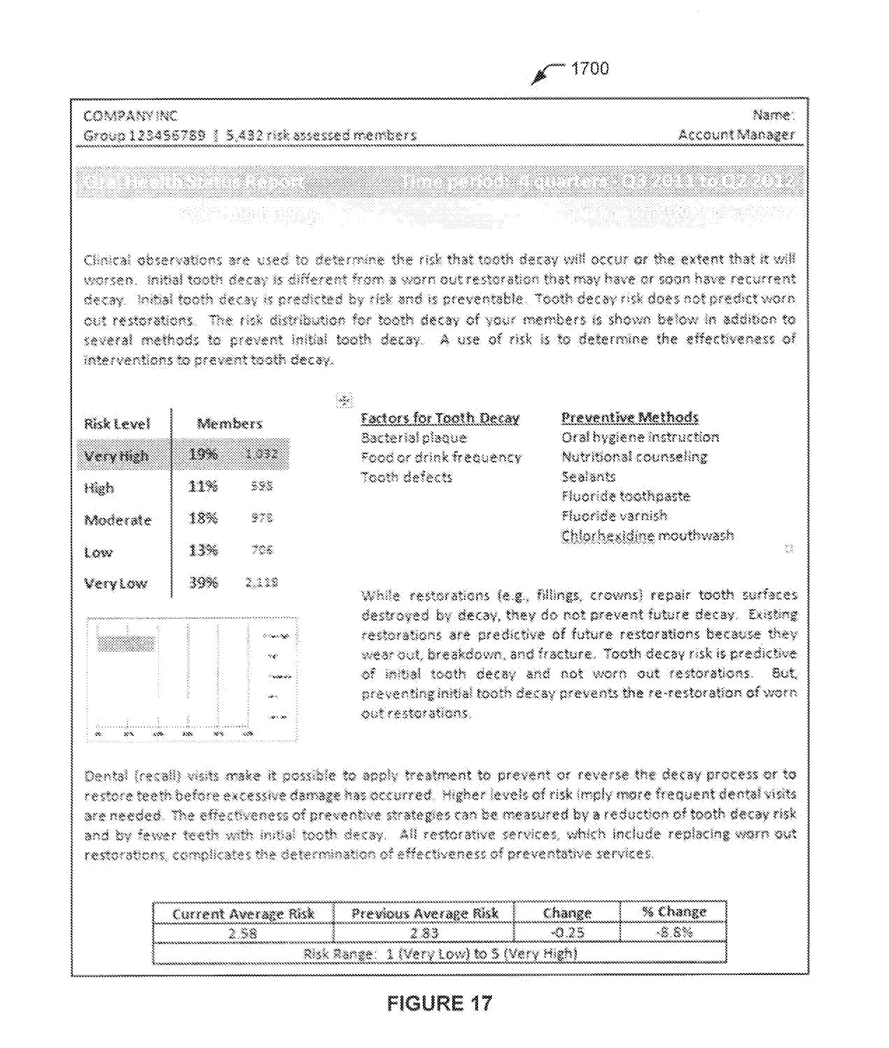

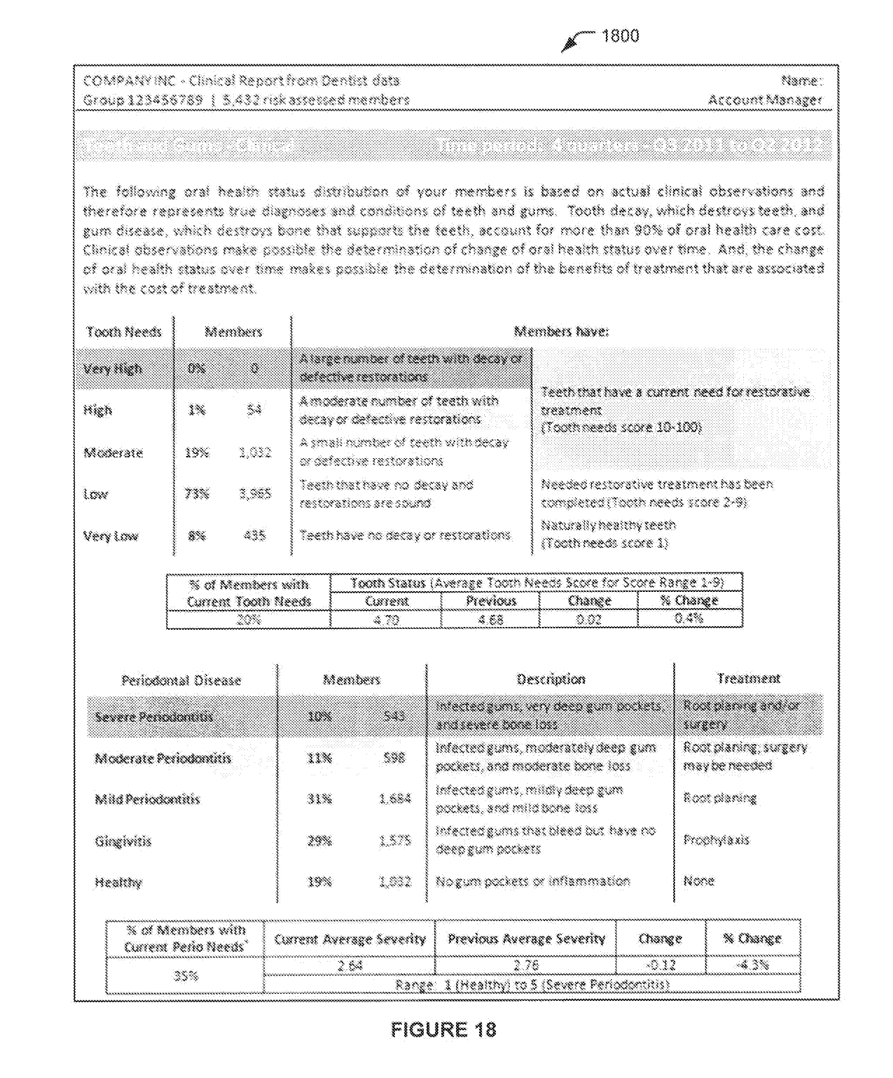

In block 590, the covered entity CE3 uses the analysis module 414 to analyze the PHI 430 (optionally combined with other data stored in the data integration hub 432 or elsewhere) and obtains results 434. All or a portion of the analysis module 414 may be implemented by the data integration hub 432. The results 434 may include and/or be displayed as one or more reports (e.g., reports 1300-1800 depicted in FIGS. 13-18, respectively).

In optional block 592, the management application 214 displays one or more reports (e.g., the reports 1300-1800 depicted in FIGS. 13-18, respectively) to the covered entities 104 (e.g., the covered entity CE3). Then, the method 580 terminates.

By way of a non-limiting example, the results 434 may be used to configure healthcare insurance coverage for a group, determine whether to pay a particular insurance claim, and inform patients about their individual health risks (and provide information to help reduce those risks).

In addition to using the de-identified data stored in the de-identified data storage 200, the management application 214 may collect and use data from other information sources 450, such as patient registration information and claims information. This information may be stored with the PHI 430 in the data integration hub 432, and/or used by the analysis module 414 to obtain the results 434. The patient registration information may regard subscribers signing up for a wellness initiative where benefit adjudication may be impacted by the OHR scores (e.g., the first and second OHR scores 220 and 222) determined by the applications 210 and 212. The insurance claim information may be used to compare care actually received by the patient P1 to care that was needed as indicated by OHR scores (e.g., the first and second OHR scores 220 and 222) determined by the applications 210 and 212. For example, the management application 214 may generate special reports showing prospective needs of the patient P1 as evidenced by the first and second OHR scores 310 and 340 alongside the care the patient P1 is actually receiving as evidenced by the insurance claims records.

The management application 214 may be used to access oral health information stored in the oral health library 216. The communication module 416 may communicate information (e.g., information obtained from the oral health library 216, one or more reports, and the like) to the patients 102.

Records concerning a single patient may be retrieved and viewed by the covered entity CE3 using the management application 214. The management application 214 implements searching and filtering features that may be used to search for and locate information related to one or more particular patients. Reports may be generated for the records retrieved.

In addition to generating reports for a particular patient, the management application 214 may generate reports for groups or populations of patients. For example, the covered entity CE3 may specify criteria that the management application 214 uses to identify a group of patients satisfying the criteria. For example, the criteria specified by the covered entity CE3 may include females of childbearing age who have an elevated risk of periodontal disease. By way of a non-limiting example, the management application 214 may send targeted wellness messages to members of the group of patients. If the targeted messages include PHI, they are delivered through the secure portal 206 (which is HIPPA compliant). If the targeted messages do not include PHI, they may be emailed to members of the group of patients. The content of the targeted messages is “owned” by the covered entity that creates and/or uploads the content.

By way of non-limiting examples, the analysis module 414 may be configured to generate one or more of the following exemplary reports:
1. Aggregated Scores: Reports on the clinical scores for patients by date.
2. Restorative Matrix: Reports the distribution of caries risk by restorative needs for a selected population (or group of patients).
3. Perio Matrix: Reports the distribution of periodontal disease risk by periodontal disease severity for a selected population (or group of patients).
4. Restorative only: Reports on the clinical observations and measurements required to calculate caries risk and restorative needs.
5. Perio only: Reports on the clinical observations and measurements required to calculate periodontal disease risk and periodontal severity.
6. Oral Cancer only: Reports on the clinical observations and measurements required to calculate cancer risk.
7. Kiosk only: Reports on OHR scores generated by kiosks executing the self-assessment application 210.
8. Estimated OHR scores only: Reports on the clinical observations and measurements required to calculate estimated OHR scores.
9. Find Duplicates: Reports on combinations of patient records that vary but appear to be the same patient. From this report, duplicate records can be merged to create a single record.
10. Patient Registrations: Reports on all details provided by an enrollee.
11. Find duplicate dentist report: Reports on combinations of dentist records that vary but appear to be the same dentist. From this report, duplicate records can be merged to create a single record.

FIGS. 13-18 depict the example reports 1300-1800, respectively, each prepared for a group of patients. The reports 1300-1500 display an overview of oral health status of a group (insured employees of “Company Inc.”) based on estimated OHR scores. The report 1600 displays an overview of oral health status of the group based on verified OHR scores. The report 1700 displays tooth decay risk for the group based on verified OHR scores. Substantially similar reports may be generated and displayed for gum disease risk, tooth needs, gum disease severity, and the like. The report 1800 displays the oral health status for the group based on verified OHR scores.

Reports may be generated from either patient supplied data (e.g., used to generate the first OHR scores 310) or the dentist supplied data (e.g., used to generate the second OHR scores 340). Then, these reports may be compared to see how accurately the patient population is assessing their oral health. Further, separate reports may be generated for each OHR score. Reports may also display changes in risks and severity occurring over a selected time period.

The management application 214 may be used to implement patient programs designed to associate patients with a particular wellness initiative. Each program can be associated with one or more group numbers identifying patients.

The covered entity CE3 may use the analysis module 414 to analyze the data stored in the hub 432 (in particular the OHR scores), and use the results 434 of the analysis to configure healthcare insurance coverage for a group (e.g., employees of a particular company).

The covered entity CE3 may use the first and second OHR scores 310 and 340 to determine whether to authorize future treatment for the patient P1 or pay a particular insurance claim for current treatment submitted by the dentist D2. In other words, compensation may be tied to evidence based indicators that proposed treatment is appropriate. Further, the covered entity CE3 may identify patients not receiving appropriate care.

As mentioned above, the information sources 450 may include claims information (e.g., a claims database). If the covered entity CE3 is an insurer, the claims database may include records identifying which procedures the dentists 101 have performed on the patient P1. These procedures may, or may not, be consistent with the second (clinical) OHR scores 340, which may mean the patient P1 is receiving too much care, too little care, or otherwise inappropriate care. The management application 214 may generate a “Gap Analysis” that identifies those patients receiving care that is inconsistent with their verified (clinical) OHR scores. For example, if the verified (clinical) OHR scores generated for the patient P1 indicate the patient has a particular level of gum disease, but the claims database indicates the patient P1 is not receiving treatment for that level of the gum disease, this “gap” between care needed and care actually received may be flagged. The Gap Analysis or portions thereof can be used to send communications to the dentists 101 and/or the patients 102. Such communications can be tailored to align patient care with patient needs as identified by the verified (clinical) OHR scores. For example, the dentists D2 (and/or the patient P1) may be notified that the patient P1 does not appear to be receiving appropriate treatment for the patient's level of gum disease. In this manner, care received can be aligned through objective evidence with care needed.

The covered entity CE3 may use the data stored in the hub 432 (in particular the OHR scores) to inform patients about their individual health risks (via email or the secure portal 206), and provide information (e.g., via targeted wellness messages and/or the oral health library 216) to help reduce those risks.

### Computing Device

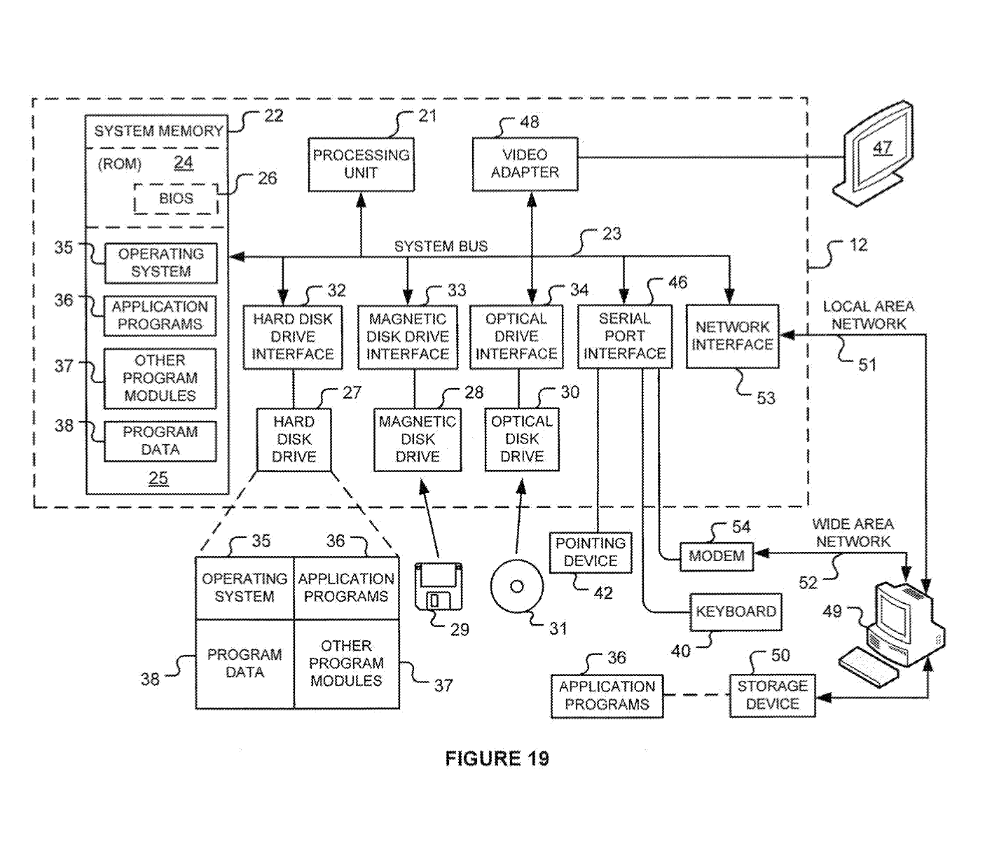

FIG. 19 is a diagram of hardware and an operating environment in conjunction with which implementations of the one or more computing devices of the system 100 may be practiced. The description of FIG. 19 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 19 includes a general-purpose computing device in the form of the computing device 12. Each of the computing devices of FIG. 1 (including the computing devices 101A-101C, 102A, 102B, 104A-104C, 105, 107, 108A, and 108B) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 19 include a local-area network (LAN) 51 and a wide-area network (WAN) 52. Such networking environments are commonplace in offices, enterprise-wide computer networks, intranets and the Internet. The network 140 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 500, 550, and 580 illustrated in FIGS. 5A, 5B, and 5C, respectively) described above. Such instructions may be stored on one or more non-transitory computer-readable media.

In some embodiments, the system memory 22 stores computer executable instructions that when executed by one or more processors cause the one or more processors to generate the reports 600-1800 illustrated in FIGS. 6-18, respectively, and described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-implemented method comprising:
receiving, at a computing system operated by a data processor, information identifying a covered entity and first de-identified data from instances of a self-assessment application executing on a plurality of patient computing devices operated by a plurality of patients, each instance of the self-assessment application including a public key associated with the covered entity, the first de-identified data including first identified data encrypted by the instances of the self-assessment application using the public key, the first identified data including first oral health risk (“OHR”) scores generated by the instances of the self-assessment application for the plurality of patients, the data processor lacking both authorization to access the first identified data and a private key associated with the covered entity required to decrypt the first de-identified data;
receiving, at the computing system operated by the data processor, the information identifying the covered entity and second de-identified data from instances of a clinical application executing on a plurality of dentist computing devices associated with a plurality of dentists, each instance of the clinical application including the public key associated with the covered entity, the second de-identified data including second identified data encrypted by the instances of the clinical application using the public key, the second identified data including second OHR scores generated by the instances of the clinical application for the plurality of patients, the data processor lacking both authorization to access the second identified data and the private key associated with the covered entity required to decrypt the second de-identified data; and
transferring, by the computing system operated by the data processor, the first and second de-identified data to a covered entity computing device operated by the covered entity, the covered entity computing device being configured to decrypt the first and second de-identified data using the private key associated with the covered entity to obtain the first and second identified data for use locally by the covered entity computing device.

2. The method of claim 1, further comprising:
receiving, at the computing system operated by the data processor, third de-identified data from a particular one of the instances of the clinical application executing on a particular one of the plurality of dentist computing devices associated with a particular one of the plurality of dentists, the particular instance of the clinical application including a private key associated with the particular dentist, the third de-identified data including third identified data associated with a particular one of the plurality of patients and encrypted by the particular instance of the clinical application using the private key, the data processor lacking both authorization to access the third identified data and the private key associated with the particular dentist required to decrypt the second de-identified data; and
transferring, by the computing system operated by the data processor, the third de-identified data to the particular dentist computing device associated with the particular dentist, the particular instance of the clinical application being configured to decrypt the third de-identified data using the private key associated with the particular dentist to obtain the third identified data for use locally by the particular instance of the clinical application.

3. The method of claim 1, wherein the covered entity computing device uses the decrypted first and second identified data to configure healthcare insurance coverage for a group including at least a portion of the plurality of patients.

4. The method of claim 3, wherein each patient in the group is an employee of a particular employer that contracted with the covered entity to provide dental insurance coverage to the group.

5. The method of claim 4, further comprising: providing a copy of the self-assessment application to the employer for distribution thereby to each patient in the group.

6. The method of claim 1, wherein the covered entity computing device uses the decrypted first and second identified data to determine whether to pay a particular insurance claim submitted to the covered entity by one of the plurality of patients.

7. The method of claim 1, wherein the covered entity computing device uses the decrypted first and second identified data to generate and display reports.

8. The method of claim 1, wherein the covered entity computing device uses the decrypted first and second identified data to determine whether to authorize future treatment for a selected one of the plurality of patients or pay a particular insurance claim submitted by one of the plurality of dentists.

9. The method of claim 1, wherein the covered entity computing device is configured to (a) access an information source storing claims information identifying which procedures the plurality of dentists have performed on the plurality of patients, and (b) perform an analysis that identifies those of the plurality of patients receiving care that is inconsistent with their second OHR scores.

10. The method of claim 1, further comprising:
providing copies of the clinical application to the plurality of dentist computing devices.

11. The method of claim 1, further comprising:
providing copies of the self-assessment application to the plurality of patient computing devices.

12. The method of claim 1, wherein for each of the plurality of patients, the first and second OHR scores each include a score for caries risk, a score for restorative needs, a score for periodontal disease risk, a score for periodontal disease severity, a score for periodontal health stability, and a score for oral cancer risk.

13. The method of claim 1, further comprising:
providing access to an oral health library stored by the computing system operated by the data processor to the instances of the self-assessment application for use thereby to determine the first OHR scores.

14. The method of claim 1, further comprising:
providing access to an oral health library stored by the computing system operated by the data processor to the instances of the clinical application for use thereby to determine the second OHR scores.

15. A computer-implemented method comprising:
downloading, at a computing system operated by a covered entity, encrypted de-identified data from a computing system operated by a data processor, the data processor lacking a private key required to decrypt the de-identified data, at least a portion of the encrypted de-identified data having been supplied to the computing system operated by the data processor by a plurality of dentist computing devices associated with a plurality of dentists, the portion having been encrypted by the plurality of dentist computing devices using a public key associated with the covered entity;
decrypting, by the computing system operated by the covered entity, the portion of the encrypted de-identified data using the private key required to decrypt the de-identified data, the decrypted portion including oral health risk (“OHR”) scores generated by a clinical application and associated with a plurality of patients treated by the plurality of dentists;
accessing, by the computing system operated by the covered entity, an information source storing claims information identifying which procedures the plurality of dentists have performed on the plurality of patients; and
identifying, by the computing system operated by the covered entity, each of the plurality of patients receiving care that is inconsistent with those of the OHR scores associated with the patient.

16. The method of claim 15, wherein the portion of the encrypted de-identified data supplied by the plurality of dentist computing devices is a second portion,
the OHR scores are second OHR scores,
at least a first portion of the encrypted de-identified data was supplied to the computing system operated by the data processor by a plurality of patient computing devices associated with the plurality of patients,
the first portion was encrypted by the plurality of patient computing devices using the public key associated with the covered entity, and
the method further comprises decrypting, by the computing system operated by the covered entity, the first portion of the encrypted de-identified data using the private key, the decrypted first portion including first OHR scores generated by a self-assessment application.

17. The method of claim 16, further comprising configuring, by the computing system operated by the covered entity, healthcare insurance coverage for a group including at least a portion of the plurality of patients based at least in part on the first and second OHR scores.

18. The method of claim 16, further comprising determining, by the computing system operated by the covered entity, whether to pay a particular insurance claim submitted to the covered entity by one of the plurality of patients based at least in part on the first and second OHR scores.

19. The method of claim 16, further comprising determining, by the computing system operated by the covered entity, whether to authorize future treatment for a selected one of the plurality of patients or pay a particular insurance claim submitted by one of the plurality of dentists based at least in part on the first and second OHR scores.

20. A computer-implemented method comprising:
downloading, at a computing system operated by a covered entity, encrypted de-identified data from a computing system operated by a data processor, the data processor lacking a private key required to decrypt the de-identified data, at least a first portion of the encrypted de-identified data having been supplied to the computing system operated by the data processor by a plurality of patient computing devices associated with a plurality of patients, at least a second portion of the encrypted de-identified data having been supplied to the computing system operated by the data processor by a plurality of dentist computing devices associated with a plurality of dentists, the first portion having been encrypted by the plurality of patient computing devices using a public key associated with the covered entity, the second portion having been encrypted by the plurality of dentist computing devices using the public key associated with the covered entity;
decrypting, by the computing system operated by the covered entity, the first and second portions of the encrypted de-identified data using the private key required to decrypt the de-identified data, the decrypted first portion including first oral health risk (“OHR”) scores generated by a self-assessment application, the decrypted second portion including second OHR scores generated by a clinical application; and
determining, by the computing system operated by the covered entity, healthcare insurance coverage for a group including at least a portion of the plurality of patients based at least in part on the first and second OHR scores.

21. The method of claim 20, wherein each patient in the group is an employee of a particular employer that contracted with the covered entity to provide dental insurance coverage to the group.
